(19) United States
(12) Patent Application Publication
(10) Pub. No.: US 2015/0209846 A1
(43) Pub. Date: Jul. 30, 2015

(54) Structured Flexible Supports and Films for Liquid-Infused Omniphobic Surfaces

(71) Applicant: President and Fellows of Harvard College, Cambridge, MA (US)

(72) Inventors: Joanna Aizanberg, Boston, MA (US); Michael Aizenberg, Boston, MA (US); Philseok Kim, Arlington, MA (US); Xi Yao, Cambridge, MA (US)

(21) Appl. No.: 14/414,598

(22) PCT Filed: Jul. 12, 2013
(86) PCT No.: PCT/US2013/050396

§ 371 Date: Jan. 13, 2015

Related U.S. Application Data
(60) Provisional application No. 61/671,442, filed on Jul. 13, 2012.
(60) Provisional application No. 61/671,645, filed on Jul. 13, 2012.
(60) Provisional application No. 61/673,705, filed on Jul. 19, 2012.
(60) Provisional application No. 61/746,296, filed on Dec. 27, 2012.

(51) Int. Cl. B08B 17/06; B32B 3/26; B32B 27/08; B32B 27/32; B32B 27/28; B32B 5/16; B05D 3/02; B05D 3/10; B05D 3/12; B05D 1/36; B32B 37/24; B32B 37/12; B32B 38/00; B32B 38/06; B32B 37/00; B32B 7/12

(52) U.S. Cl. CPC B08B 17/065; B32B 7/12; B32B 3/26; B32B 3/263; B32B 27/08; B32B 27/322; B32B 27/283; B32B 5/16; B05D 3/0218; B05D 3/107; B05D 3/104; B05D 3/12; B05D 1/36; B32B 37/24; B32B 37/1284; B32B 38/0012; B32B 38/0004; B32B 38/06; B32B 37/0038; B32B 2255/10; B32B 2264/102; B32B 2307/746; B32B 2307/754; B32B 2457/12; B32B 2535/00; B32B 2590/00; B32B 2556/00; B32B 2419/04; B32B 2419/06; B32B 2405/00; B32B 2551/00; B32B 2419/00; B32B 2037/243; B32B 2037/1246; B32B 2038/002; B32B 2038/0016

(57) ABSTRACT

An article with different surface properties on opposing sides is provided including a sheet having a first side and a second side, wherein the first side displays low adhesion properties, said first side comprising a roughened, porous or structured surface and a wetting liquid disposed upon the surface to form a stable liquid film; and wherein the second side displays a second property dissimilar from that of the first side. The article can be adhered to a variety of objects to impart anti-fouling properties.

### CROSS-REFERENCE TO RELATED APPLICATIONS

The present application claims priority to U.S. Patent Application No. 61/671,442, filed Jul. 13, 2012, U.S. Patent Application No. 61/671,645, filed Jul. 13, 2012, U.S. Patent Application No. 61/673,705, filed Jul. 19, 2012, and U.S. Patent Application No. 61/746,296, filed Dec. 27, 2012, the entire contents of which are hereby incorporated by reference.

The present application related to the following co-pending applications filed on even date herewith:

International Application entitled SELECTIVE WETTING AND TRANSPORT SURFACES, filed on even date herewith;

International Application entitled SLIPS SURFACE BASED ON METAL- CONTAINING COMPOUND, filed on even date herewith;

International Application entitled MULTIFUNCTION REPELLENT MATERIALS, filed on even date herewith; and

International Application entitled SLIPPERY LIQUID-INFUSED POROUS SURFACES HAVING IMPROVED STABILITY, filed on even date herewith.

### INCORPORATION BY REFERENCE

All patents, patent applications and publications cited herein are hereby incorporated by reference in their entirety in order to more folly describe the state of the art as known to those skilled therein as of the date of the invention described herein.

### BACKGROUND

Current development of liquid-repellent surfaces is inspired by the self-cleaning abilities of many natural surfaces on animals, insects, and plants. Water droplets on these natural surfaces roll off or slide off easily, carrying the dirt or insects away with them. The presence of the micro/nanostructures on many of these natural surfaces has been attributed to the water-repellency function. These observations have led to enormous interests in manufacturing biomimetic water-repellent surfaces in the past decade, owing to their broad spectrum of potential applications, ranging from water-repellent fabrics to friction-reduction surfaces.

Surfaces having high slip properties and demonstrating anti-adhesive and anti-fouling properties are known. Slippery Liquid-Infused Porous Surfaces (SLIPS) article includes a solid surface having surface features that provide a surface roughness. The roughened surface, which is appropriately chemically or physically modified/conditioned when needed to provide surface properties compatible with the applied lubricant (referred to herein as “roughened surface”), is coated with a wetting liquid that has a high affinity to conditioned surface, wets the roughened surface, filling the hills, valleys, and/or pores of the roughened surface, and forming an ultra-smooth surface over the roughened surface. Due to the ultra-smooth surface resulting from wetting the roughened surface with the wetting liquid, liquids, solids and gases do not adhere to the surface. SLIPS surfaces are discussed in International Patent Application WO 2012/100099 and International Patent Application WO 2012/100100, both filed Jan. 19, 2012, and International Patent Application No. PCT/US2013/21056, filed Jan. 10, 2013, the contents of which are hereby incorporated by reference in their entireties.

Many surfaces that can benefit from high slip, and anti-adhesive and/or anti-fouling properties are not amenable to surface treatment such as surface roughening treatments used in preparing SLIPS surfaces. In addition, the high slip and low adhesive properties of SLIPS surfaces makes it difficult to adhere such surfaces to other articles. Lastly, many applications require that an article exhibit different properties on different surfaces of the article, e.g., different surfaces having slip and non-slip properties.

### SUMMARY

A two-dimensional article (sheets, films, tapes, tiles, thin coatings, etc.) having a first side displaying non-sticking and anti-fouling properties (e.g., SLIPS) and a second opposing side displaying a dissimilar function, such as wetting, sticky, or adhesive properties is described. In one or more embodiments, the two-dimensional article possesses surfaces having significantly different degrees of stickiness. The disclosed two-dimensional articles have a thickness substantially less than the total surface area of the article, such that the articles consist essentially of a first side and a second side having dissimilar functions.

In one aspect, a bifunctional article having different surface properties on opposing sides, includes a sheet having a first side and a second side, wherein the first side displays low adhesion properties, said first side comprising a roughened, porous or structured surface and a wetting liquid disposed upon the surface to form a stable liquid film; and wherein the second side displays a second property dissimilar from that of the first side.

In one or more embodiments, the sheet is free standing, or the sheet is shaped to conform to a surface having a predetermined shape.

In any of the preceding embodiments, the sheet is rigid or flexible.

In any of the preceding embodiments, the second property is selected from the group consisting of wettability by a selected liquid other than the wetting liquid, stickiness and adhesiveness, and for example, the second property is adhesiveness.

In any of the preceding embodiments, the second side includes an adhesive layer.

In one or more embodiments, the adhesive layer is suitable for permanent adhesion to the surface of an object.

In one or more embodiments, the adhesive layer is suitable for reversible adhesion to the surface of an object.

In one or more embodiments, the adhesive layer is pressure sensitive.

In any of the preceding embodiments, the first side includes a SLIPS disposed on the first side of the sheet.

In one or more embodiments, the SLIPS layer comprises a porous or structured nanomaterial secured to the substrate using an adhesive.

In one or more embodiments, the SLIPS layer comprises a porous material and the adhesive penetrates into a lower portion of the porous material.

In any of the preceding embodiments, the first side comprises a SLIPS layer integral with the sheet.

In any of the preceding embodiments, the bifunctional article further includes a protective layer disposed over one or both of the first and second sides of the sheet.

In one or more embodiments, the protective layer is a sacrificial layer.

In any of the preceding embodiments, the article is wound article, optionally including a supporting mandrel.

In any of the preceding embodiments, the article is a film, tape, tile fabric, paper, sleeve, or thin coating.

In any of the preceding embodiments, the article is housed in a protective housing to reduce loss of wetting liquid during storage.

In any of the preceding embodiments, the article has a thickness in the range of about 1 μm to about 1 cm.

In any of the preceding embodiments, the article has a thickness in she range of about 1 cm to about 10 cm.

In any of the preceding embodiments, wherein the sheet comprises polydimethylsiloxane and the roughened, porous or structured surface comprises a polytetrafluoroethylene sheet, said polytetrafluoroethylene sheet secured to the polydimethylsiloxane sheet by cured polydimethylsiloxane precursor.

In any of the preceding embodiments, the sheet is a bilayer and the first layer of the bilayer has a surface displaying the low adhesion properties and the second layer of the bilayer has a surface displaying the second dissimilar property.

In any of the preceding embodiments, the sheet comprises a single porous sheet having different surface chemistry on the first and second sides of the substrate, the first surface chemistry displaying the low adhesion properties and the second surface chemistry displaying the second dissimilar property.

In another aspect, a method of making an article having different surface properties on opposing sides includes providing a substrate having a first side and a second side, the second side optionally containing an adhesive backing, applying a glue layer, said layer having a thickness, on the first side of the substrate; and locating a porous or structured layer in the glue layer, the porous or structured comprising at least one of pores and voids; wherein the glue partially infuses through at least a portion of the thickness of the porous or structured layer into at least one of the pores and voids of the porous or structured layer, and wherein there remains a portion of the thickness of the porous or structured layer that has at least one of unfilled voids and unfilled pores.

In one or more embodiments, the thickness of the glue layer is selected to infuse the glue through a predetermined portion of the thickness of the porous or structured layer which is less than the total thickness of the porous or structured layer.

In one or more embodiments, the method is conducted in a roll-to-roll continuous process.

In one or more embodiments, the substrate comprises polydimethylsiloxane sheet, the glue comprises a curable polydimethylsiloxane precursor, and the porous or structured layer comprises a porous polytetrafluoroethylene sheet; and wherein the curable polydimethylsiloxane precursor is cured after infusing the polytetrafluoroethylene sheet with the curable polydimethylsiloxane precursor.

In another aspect, a method of making an article with different surface properties on opposing sides include continuously feeding out a substrate from a roll into coating zone, said substrate comprising a reactive layer on a first side of the substrate and optionally containing an adhesive backing on the second side of the substrate; converting the reactive layer into a porous or structured layer in the reaction zone; and taking up the substrate comprising a porous or structured layer on a receiving roll at a location outside of the reaction zone.

In one or more embodiments, the reactive layer comprises an aluminum layer and the reactive zone comprises a heated zone with high moisture content.

In one or more embodiments, the reactive zone comprises at least one of particle spraying, sandblasting, embossing, imprinting, electrodeposition and surface etching.

In one or more embodiments, the method further includes applying a wetting liquid to the porous or structured layer, wherein the wetting liquid fills at least one of the unfilled voids and unfilled pores of the porous or structured layer and forms a stable liquid film over the porous or structured layer.

In one or more embodiments, the method further includes applying a protective layer over one or both of the porous or structured layer and second side optionally containing an adhesive backing.

In another aspect, a method of applying a SLIPS surface to an object includes providing an article according to any of the preceding embodiments; and contacting the second side of the article to an exposed surface of the object, said contacting causing an adhesive layer to adhere the second side of the article to the exposed surface of the object.

In one or more embodiments, the second side includes an adhesive layer.

In one or more embodiments, the adhesive layer comprises a double-stick sheet having an adhesive layer on both sides, such that one side of the double-stick sheet adheres to the exposed surface of the object and the other of the double-stick sheet adheres to the second side of the article.

In one or more embodiments, the first side of the article is selected for protection of the object against one or more of contamination by liquids, complex fluids, solids, insects and microorganisms.

In one or more embodiments, the first side of the article is selected for imparting one or more of anti-icing, anti-graffiti, anti-dirt, antifouling or anti-biofouling properties to the object.

### BRIEF DESCRIPTION OF THE DRAWINGS

The above and other objects and advantages of the present invention will be apparent upon consideration of the following detailed description, taken in conjunction with the accompanying drawings, in which like reference characters refer to like parts throughout, and in which:

FIG. 1 is a schematic of the overall design of Slippery Liquid-Infused Porous Surfaces (SLIPS).

FIG. 2 is a general schematic of (A) a bifunctional sheet according to one or more embodiments and (B) a bifunctional sheet having removable protective layers.

FIG. 3 is a general schematic of a bifunctional sheet according to one or more embodiments.

FIG. 4 is a schematic illustration of a process for fabricating a bifunctional sheet according to one or more embodiments.

FIGS. 5A-5H are a series of time lapsed images of aluminized PET sheet (˜50 nm thick aluminum) in the process of being structured through hydrolysis in a “boehmitization” process in a 70° C. water bath used to prepare a SLIPS surface on a bifunctional sheet according to one or more embodiments.

FIGS. 6A-6F are a series of images demonstrating the boehmitization of a aluminized paper foil and its transformation into a bifunctional sheet having SLIPS properties after its application to a third surface.

FIG. 7 is a photographic image of a bifunctional sheet prepared using filter paper and having SLIPS properties on one side and regular filter paper properties on the other side according to one or more embodiments at a tilt angle of (A) zero and (B) greater than zero.

FIG. 8 is shows a schematic for formation of a 2-layer porous solid that is composed of two different types of materials in accordance with certain embodiments of the present disclosure.

FIG. 9 is a photograph of a bifunctional polydimethylsiloxane (PDMS)/SLIPS Teflon sheet attached to a checkerboard (A) before and (B) after infusing with lubricant.

FIGS. 10A-D show scanning electron microscopy (SEM) images of 2500 grit alumina sandpaper SLIPS.

FIG. 11 shows a schematic for the preparation of a patterned SLIPS on a flat, smooth solid in accordance with certain embodiments of the present disclosure.

FIG. 12 shows a schematic for the preparation of a patterned SLIPS on a 2.5 D patterned solid in accordance with certain embodiments of the present disclosure.

FIG. 13 shows water contact angle hysteresis of unmodified and modified sandpaper as disclosed herein.

### DETAILED DESCRIPTION OF THE INVENTION

The present disclosure describes slippery surfaces referred to herein as Slippery Liquid-Infused Porous Surfaces (SLIPS). In certain embodiments, the slippery surfaces of the present disclosure exhibit anti-adhesive and anti-fouling properties. The slippery surfaces of the present disclosure are able to prevent adhesion of a wide range of materials. Exemplary materials that do not stick onto the surface include liquids, solids, gases (or vapors) and mixtures thereof. For example, liquids such as water, oil-based paints, hydrocarbons and their mixtures, organic solvents, complex fluids such as crude oil, protein-containing fluids and the like can be repelled. The liquids can be both pure liquids and complex fluids. In certain embodiments, SLIPS can be designed to be omniphobic, where SLIPS exhibit both hydrophobic and oleophobic properties. As another example, organisms such as bacteria, insects, fungi, algae and the like can be repelled. As another example, solids such as ice, paper, sticky notes, or inorganic particle-containing paints, dust particles can be repelled or easily cleaned/removed. The list is intended to be exemplary and the slippery surfaces of the present disclosure are envisioned to successfully repel numerous other types of materials.

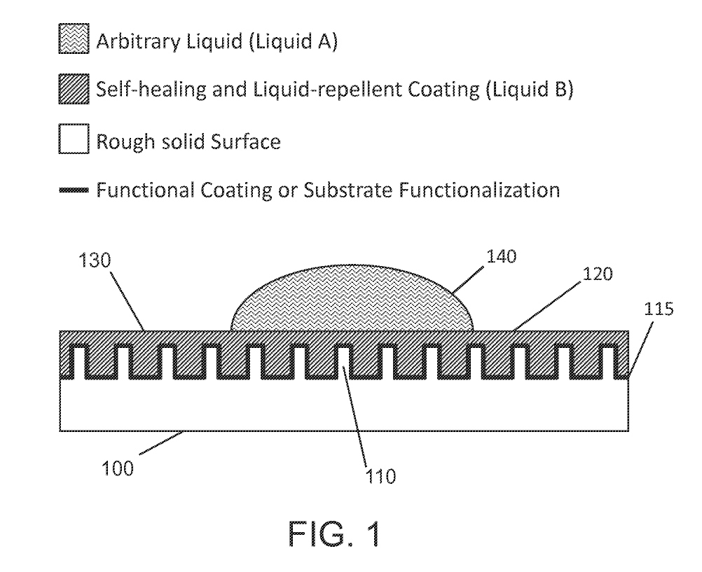

A schematic of the overall design of Slippery Liquid-Infused Porous Surfaces (SLIPS) is illustrated in FIG. 1. As shown, the article includes a solid surface 100 having surface features lid that provide a certain roughness (i.e. roughened surface) with Liquid B 120 applied thereon. Surface features 110 can be of a variety of shapes, sizes, regularity, porosity, topography, and periodicity, as should be clear to those experienced in the art from the background described in the prior art. The surface features 110 optionally are chemically or physically modified when needed with a layer 115 to ensure high affinity to Liquid B 120 applied thereon. Liquid B wets the roughened surface, filling the hills, valleys, and/or pores of the roughened surface, and forming an ultra-smooth surface 130 over the roughened surface. Due to the ultra-smooth surface resulting from wetting the roughened surface with Liquid B, Object A 148 does not adhere to and moves freely on/off the surface.

In certain embodiments, the SLIPS surface makes up one side of a freestanding sheet or film, e.g., a two-dimensional article. By “two-dimensional article” as used herein, it is meant that two dimensions of the article's three dimensions, e.g., length and width, are much greater than the third, e.g., thickness. The article can typically take the form of a ribbon, tape or sheet, and in some embodiments it can be flexible. Although the two-dimensional article can be prepared for application to a substrate or support, for example, by having an adhesive backing, it is prepared in a “free-standing” format, that is, unsupported or unadhered to an underlying support or substrate. In some embodiments, the freestanding sheet or film has a first side displaying non-sticky and anti-fouling properties (e.g., SLIPS) and a second opposing side displaying a dissimilar function, such as just conventional wetting and sticking. In certain embodiments, the second opposing side can have adhesive properties. Such a format is useful in applying the SLIPS surface onto other bodies, surfaces, objects, structural materials or devices.

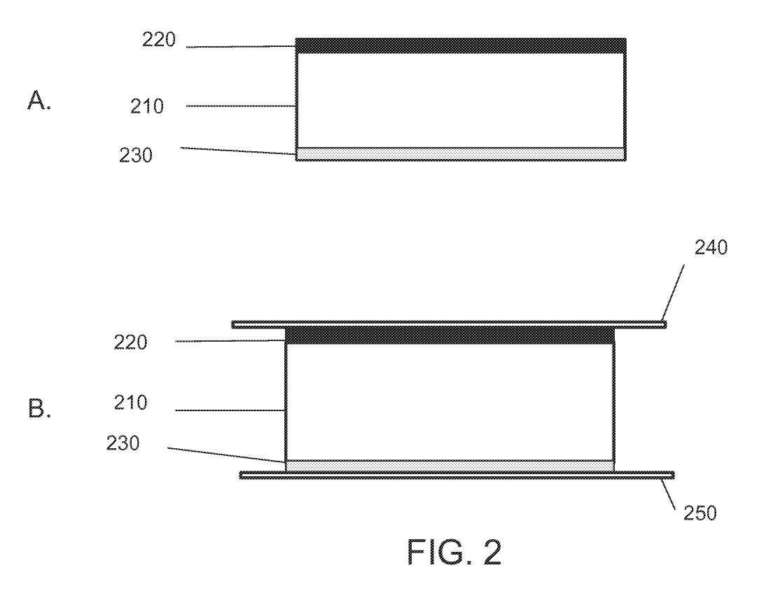

The cross-section of a freestanding bifunctional film or sheet 280 is shown schematically in FIG. 2A. The bifunctional sheet contains a base sheet or substrate 218 (the dimensions of the figure are not accurate and the sheet is assumed to be made in a desired size, e.g., much larger or thinner and to have a wide range of aspect ratios, e.g., much greater than the aspect ratio shown). The sheet can be any dimension and is typically of a thickness, flexibility and areal dimension that permit it to be taken up on a roll or spindle, if so desired. The ability to wind or roll the base sheet makes it easy to process the sheet into the bifunctional freestanding sheet or film of the invention. In addition, it provides a means of convenient storage, transport and application. The sheet may be a fibrous sheet, such as paper, woven or porous cloth made of natural or synthetic polymers; it can be made of metal or plastic. It can be a single layer or made up of multiple layers. The sheet can be porous or dense. The sheet should be of a material and thickness to permit processing and to be freestanding. The sheet desirably is of a thickness that provides flexibility, for example, to permit it to be rolled, so that it can be taken up and dispensed from a roll or spindle. The sheet can be shaped as a tape. Flexibility also permits the freestanding bifunctional sheet to bend around non-planar surfaces, so that it can conform to and stick to such surfaces (where, for example, the opposing surface includes an adhesive). The sheet is typically of a thickness in the range of 10 μm to 1 cm, although there are no strict upper or lower limits.

In one or more embodiments, the sheets can be prepared in specific shapes designed to be attached to the surface of certain geometries such as triangular, rectangular, square, circular or arbitrarily shaped forms. Such forms can be, for example, sheets shaped and sized to attach to road signs, solar panels, buildings, and the like to prevent adhesion, such as dirt build up. In certain applications, it is desirable that the flexible sheet be transparent. In addition, a SLIPS sheet can be applied to the interior or outer surface of a 3D object (e.g. rods, bars, cylinders, pipes, containers, bottles, large vessels, enclosures, counter tops, lids, covers, ceilings, walls, roofs).

In one or more embodiments, the sheet has a first surface which is roughened, structured or porous and infused with a wetting liquid that provides an ultrasmooth, slippery surface 220. The roughened, structured or porous surface can be a functionalized or modified portion of the sheet 218, or it can be a layer that is applied to sheet 210. By way of example, the roughened, structured or porous surface can be a porous sheet applied onto the base sheet. In other embodiments, the roughened, structured or porous surface can be a molded micro- or nanostructure, or it can be a roughened surface obtained by particle spraying, sandblasting, embossing, imprinting, electrodeposition, colloidal assembly, layer-by-layer deposition or etching the surface of the substrate. In other embodiments, it can result from a chemical reaction of the underlying substrate. The roughened surface is further chemically or physically functionalized, when needed, to provide the high affinity to a lubricant that allows the lubricant to be stably attached to the surface. The layer of wetting liquid is thin and relatively immobilized on the roughened or porous surface, that is, the interaction between the substrate and the wetting liquid is sufficiently strong to prevent the free flow of the liquid over and from the surface. In one or more embodiments, volume of wetting liquid is present at a level sufficient to just cover the highest projections of the roughened surface. Exemplary thicknesses for the lubricating liquid range from less than 10 nm to more than 100 μm, or between 1-100 μm. In other embodiments, the lubricant layer follows the topography of the structured surface and forms a conformal smooth coating (e.g., instead of forming a smooth layer that overcoats all the textures). For example, the lubricant may follow the topography of the structured surface if the thickness of the lubricant layer is less than the height of the textures. While a smooth layer that overcoats all the textures provides the best performance, conformal smooth lubricant coating, which follows the topography of the structured surface and can arise from the diminished lubricant layer, still shows significantly better performance than the underlying substrate that was not infused with the lubricant.

SLIPS surfaces can be designed based on the surface energy matching between a lubricating fluid and a solid to form a stable liquid layer that is not readily removed from the surface. In some embodiments, SLIPS can be designed based on one or more of the following three factors: 1) the lubricating liquid can infuse into, wet, and stably adhere within the roughened surface, 2) the roughened surface can be preferentially wetted by the lubricating liquid rather than by the liquid, complex fluids or undesirable solids to be repelled, and therefore the lubricating layer cannot be displaced by the liquid or solid to be repelled, and 3) the lubricating fluid and the object or liquid to be repelled can be immiscible and may not chemically interact with each other. These factors can be designed to be permanent or lasting for time periods sufficient for a desired life or service time of the SUPS surface or for the time till a reapplication of the partially depleted infusing liquid is performed.

The first factor (a lubricating liquid which can infuse into, wet, and stably adhere within the roughened surface) can be satisfied by using micro- and/or nanotextured, rough substrates whose large surface area, combined with physical and/or chemical affinity for the wetting liquid, facilitates complete wetting by, and adhesion of, the lubricating fluid, and its retention in the porous network due to strong capillary forces. More specifically, the roughness of the roughened surface, R, defined as the ratio between the actual and projected areas of the surface, may be any value greater than or equal to 1, such as 1 (flat surface), 1.5, 2, 5 or even higher.

To satisfy the second factor (that the roughened surface can be preferentially wetted by the lubricating liquid rather than by the liquid, complex fluids or undesirable solids to be repelled), a determination of the chemical and physical properties required for working combinations of substrates and lubricants can be made. This relationship can be qualitatively described in terms of affinity; to ensure that the Object A to be repelled (fluid or solid) remains on top of a stable lubricating film of the lubricating liquid, the lubricating liquid must have a higher affinity for the substrate surface than materials to be repelled, such that the lubricating layer cannot be displaced by the liquid or solid to be repelled. This relationship can be described as a “stable” region. As stated above, these relationships for a “stable” region can be designed to be satisfied permanently or for a desired period of time, such as lifetime, service time, or for the time till the replenishment/reapplication of the partially depleted infusing liquid is performed.

To satisfy the third factor (that the lubricating fluid and the object or liquid to be repelled can be immiscible and may not chemically interact with each other), the enthalpy of mixing between the two should be sufficiently high (e.g., water/oil; insect/oil; ice/oil, etc.) that they phase separate from each other when mixed together, and/or do not undergo substantial chemical reactions between each other. In certain embodiments, the two components are substantially chemically inert with each other so that they physically remain distinct phases/materials without substantial mixing between the two. For excellent immiscibility between a lubricating liquid and a liquid to be repelled, the solubility in either phase should be <500 parts per million by weight (ppmw). For example, the solubility of water in perfluorinated fluid (e.g., 3M Fluorinert™) is on the order of 10 ppmw; the solubility of water in polydimethylsiloxane (Liquid B, MW=1200) is on the order of 1 ppm. In some cases, SLIPS performance could be maintained transiently with sparingly immiscible liquids. In this case, the solubility of the liquids in either phase is <500 parts per thousand by weight (ppthw). For solubility of <500 ppthw, the liquids are said to be miscible. For certain embodiments, an advantage can be taken of sufficiently slow miscibility or mutual reactivity between the infusing liquid and the liquids or solids or objects to be repelled, leading to a satisfactory performance of the resulting SLIPS over a desired period of time.

Further detail on the selection of components for a SLIPS surface can be found in International Patent Application WO 2012/100099 and International Patent Application WO 2012/100100, both filed Jan. 19, 2012, International Patent Application No. PCT/US2013/21056, filed Jan. 10, 2013; and International Patent Application No. PCT/2012/63609, filed Nov. 5, 2012. Additional detail can be found in U.S. Application No. 61/671,442, filed Jul. 13, 2012, entitled SELECTIVE WETTING AND TRANSPORT SURFACES; U.S. Application No. 61/671,645, filed Jul. 13, 2012, entitled HIGH SURFACE AREA METAL OXIDE-BASED COATING FOR SLIPS; and U.S. Application No. 61/673,705, filed Jul. 19, 2012, entitled MULTIFUNCTION REPELLENT MATERIALS, International Application entitled SLIPS SURFACE BASED ON METAL-CONTAINING COMPOUND filed on even date herewith; International Application entitled SELECTIVE WETTING AND TRANSPORT SURFACES filed on even date herewith; and International Application entitled MULTIFUNCTION REPELLENT MATERIALS filed on even date herewith, the contents of which are hereby incorporated by reference in their entireties.

As discussed below, such a surface can be introduced onto the sheet in a number of ways, including controlled infiltration of a wetting liquid into a porous sheet, functionalization or chemical treatment of a metallic thin film deposited on the sheet, and the like. Manufacturing details are discussed in greater detail below.

The second surface 238 demonstrates a property that is different from the first surface 220. In one or more embodiments, the property of the second surface can include wettability by a selected liquid (different from the lubricating liquid), adhesive capability, and/or stickiness, e.g., the ability to firmly adhere to another body. The second surface 238 can be the original surface of material 218, a functionalized or modified portion of the sheet 210, or it can be a layer that is applied to sheet 210.

In one or more embodiments, the second surface 230 includes an adhesive layer applied to the freestanding sheet. The adhesive layer can be capable of permanent adhesion to a surface, e.g., a glue, or reversible adhesion, e.g., a tacky surface like that used in Post-It® notes or Scotch tape. Pressure sensitive adhesives can be applied to provide an adhesive surface that bonds to a body on contact. Exemplary adhesives include animal or plant-based glues, urea-formaldehyde resin, acrylic, epoxy, urethane, cyanocellulose, cyanoacrylate, latex, starch, resorcinol glue, acrylonitrile glue, ethylene vinyl acetate, polyamide, polyester resin glue, polyvinyl acetate, polyvinyl alcohol, polyvinylpyrrolidone, rubber cement, silicone glue, and other adhesives that are also well-known in the art. In certain embodiments, rubbers and silicones that are removable and epoxies, acrylates and modified acrylates that can be varied for bonds ranging from permanent to removable can be used.

In other embodiments, commercially available adhesive backed sheets and tapes may be used. For example, 3M offers adhesive backed sheets using a wide range of backings having a number of different potential applications. Table 1 provides exemplary backings with a variety of adhesive backings.

TABLE 1
Exemplary Backing Materials

| | |
|---|---|
| Backings | Characteristics |

Paper

| | |
|---|---|
| Crepe | Conformable, easy tear. |
| Flatback | Strong, smooth, good for straight line masking. |
| Kraft | Strong, some versions are repulpable. |
| Tissue | Thin, porous to allow adhesive penetration of sheet. |

Plastic

| | |
|---|---|
| Polyester | Strong even when thin, chemical resistant, high temperature |
| | resistance. |
| Polypropylene | Resistant to most solvents, conformable, tear resistant. |
| Polyethylene | Conformable, easy to stretch, chemical/acid/moisture resistant, |
| | economical. |
| Polyethylene/Polypropylene | Conformable, chemical/acid/moisture resistant. |
| Co-polymer | |
| UHMW - Polyethylene | High abrasion resistance, low coefficient of friction, anti-stick |
| | surface easy to clean. |
| Polyvinyl Chloride (Vinyl) | Conformable, abrasion resistant, resistant to most chemicals. |
| Polyimide (e.g., Kapton ®) | High temperature resistance, excellent dimensional stability, |
| | good insulation properties. |
| Polyamide (Nylon) | High temperature resistance, high strength and toughness, |
| | good chemical resistance but can absorb moisture. |
| Polytetrafluorethylene (PTFE) | Low coefficient of friction, excellent high temperature and |
| | chemical resistance, anti-stick/release properties. |
| Polyvinyl Alcohol (PVA) | Water-soluble, organic solvent resistant, high temperature |
| | resistance. |
| Polyurethane | Abrasion/scratch resistant, impact/puncture resistant, UV and |
| | corrosion resistant. |
| Polyvinyl Fluoride (e.g., | Excellent weather resistance, excellent long-term UV |
| Tedlar ®) | resistance, thin yet stiff feel. |

Cloth

| | |
|---|---|
| Cotton | Strong, easy tear by hand, soft and drapable. |
| Glass Cloth | Strong, high temperature resistance, flame-resistant. |
| Polyethylene Coated | Strong yet hand-tearable, abrasion resistant, water-resistant, |
| | conformable. |

Non-Woven

| | |
|---|---|
| Fiber | Air permeable, strong enough to hold expanding foams. |

Metals

| | |
|---|---|
| Aluminum | Heat and light reflective, moisture and chemical resistant, |
| | flame-resistant, outdoor weather resistant, conformable. |
| Lead | Electrically conductive, acid resistant, high conformability, x- |
| | ray opacity. |

Rubber

| | |
|---|---|
| Neoprene | Abrasion resistant, die-cuttable. |

Combination (Laminates)

| | |
|---|---|
| Paper/Polyethylene | Weather and chemical resistant, hand tearable, stretch |
| | resistant. |
| Metalized/Polyester | Reflective, decorative. |
| Glass Cloth/PTFE | High temperature resistance, high strength. |
| Glass Cloth/Aluminum | Very high temperature resistance, high strength. |
| Non-Woven/Aluminum | High heat and cold resistance. |

Taken from http://solutions.3m.com/wps/portal/3M/en_US/3M_Industrial/Tapes/Resources/3M-Backing-Materials/

Other commercially available adhesive-backed sheets and tapes of polymeric, fibrous or metal composition may also be used.

In other embodiments, the first and second surfaces may include optional protective sheets 240, 258 disposed over the first and second sides of the bifunctional sheet, respectively, as shown in FIG. 2B. The protective sheet protects the surfaces from contact and subsequent damage before the service. In certain embodiments, the protective sheets are sacrificial and readily removable. A sacrificial layer is a layer that dissolves/evaporates/“vanishes” upon application or chemical treatment. Removable protective sheets can be used when roiling the bifunctional sheet onto a spindle or central cylinder. The protective sheet prevents the adhesive layer from adhering to the adjacent coiled layers in the roll. In certain embodiments, the protective sheets are the packaging material itself, for example, a bifunctional sheet can be packaged in a vacuum sealed bag. In use, the protective sheet can be peeled or teared off the bifunctional sheet to expose the adhesive layer and/or SLIPS surface. In certain embodiments, the protective sheets are made to be dissolved or decomposed after the installation of a bifunctional sheet such that certain environmental changes or time changes allow the bifunctional sheet to automatically expose the SLIPS surface.

In one or more embodiments, the freestanding bifunctional sheet or tape is provided as a ready to apply tape or sheet wound on a central mandrel. The tape or sheet includes a SLIPS or SLIPS precursor side and an adhesive side, optionally also including a protective, sacrificial protective sheet between the successive windings of the coiled sheet.

In other embodiments, the freestanding bifunctional sheet or tape is provided as individual sheets. The sheets have an adhesive backing with an optional sacrificial or protective coating that is removable to allow the user to apply the sheet to any desired surface or body. In one or more embodiments, the sheets are capable of being cut into any desired shape before application.

In one or more embodiments, a kit is provided in which the bifunctional sheet or tape is stored in a scalable bag, e.g., in the form of individual sheets or as a rolled tape, which prevents or reduces evaporative loss of the lubricating liquid.

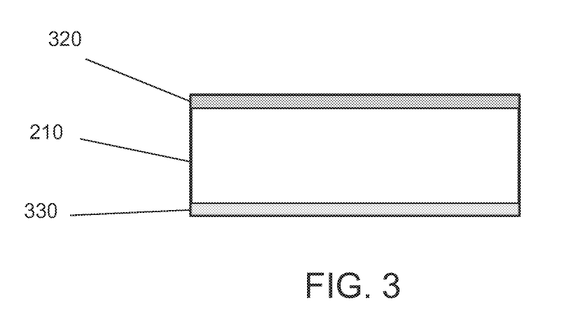

FIG. 3 is a schematic illustration of another embodiment of the invention, in which one or both the first and second surfaces 328, 330 are precursor layers to the final SLIPS surface and second surface functionality, respectively. The bifunctional freestanding sheet can be supplied to a user in its precursor state, and the user can make the final adjustments to convert it into the final form. In other embodiments, the first surface is selected to provide a precursor to a SLIPS surface. In one or more embodiments, a SLIPS precursor layer can include a roughened, structured or porous surface; however, the wetting liquid, which would convert the surface into a SLIPS surface, is not applied.

In other embodiments, the precursor layer is selected to provide a precursor to an adhesive layer as the second surface 330. The second surface 338 includes a surface that possesses properties to enhance gluing and adhesion strength when attached to a body. For example, the second surface could have a roughened surface to enhance adhesion. In other embodiments, the surface is selected to have strong wetting to glue. In one or more embodiments, second surface 330 possesses physical or surface energy properties that provide for wettability. The wetting property allows for strong adhesion to a body when glued. Exemplary adhesives useful in connection with the present disclosure include, but are not limited to animal or plant-based glues, urea-formaldehyde resin, acrylic, epoxy, urethane, cyanocellulose, cyanoacrylate, latex, starch, resorcinol glue, acrylonitrile glue, ethylene vinyl acetate, polyamide, polyester resin glue, polyvinyl acetate, polyvinyl alcohol, polyvinylpyrrolidone, rubber cement, silicone glue, and other adhesives that are also well-known in the art.

In one or more embodiments, the second surface can be a surface that has been treated with an adhesive layer. For example, one can apply a double-sided tape onto the surface to be protected and on top of it apply the SLIPS one-sided tape/film/sheet. This results in a significant simplification of the process of surface treatment in that an adhesive applied to the back of the SLIPS tape/film/sheet is not required.

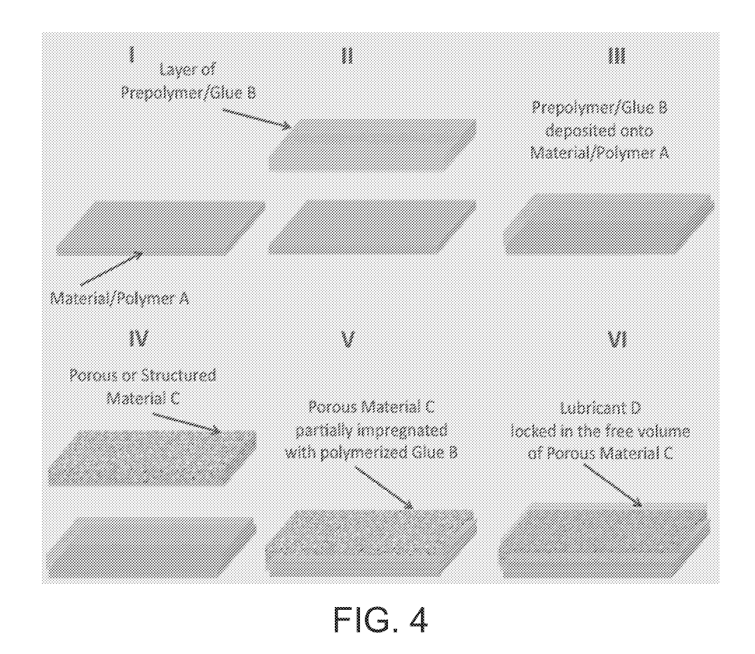

In one or more embodiments, a bifunctional two-dimensional article including a SLIPS surface or SLIPS precursor surface is prepared by applying a porous sheet onto the two-dimensional, free-standing base, such as e.g., paper made of polytetrafluoroethylene (PTFE) or other polymer. The schematic for the method is shown in FIG. 4.

The principal components of the method include:
Material/Polymer A, which is used as the substrate for the SLIPS or SLIPS precursor surface. The substrate can be a commercially available backing material, for example, with adhesive layer preapplied. The substrate can also include a protective strip that covers the adhesive layer
Prepolymer/Glue B, which is a glue capable of forming a permanent bond between the substrate and the porous or structured material
Porous or structured Material C, which contains a roughened surface or a porous framework. These features are used to form the stable lubricating layer that provides the SLIPS surface
Lubricant D, which wets the porous or structured material.

The fabrication method involves depositing onto a supporting film of Material/Polymer A (shown in FIG. 4 I) of a layer of Prepolymer/Glue B (shown in FIG. 4 II), such that B adheres firmly to A (as shown in FIG. 4 III), which can be achieved by a variety of curing/partial curing conditions (thermal, irradiation, chemical, etc.). In fact, Material A can even result from selective curing/polymerization of Prepolymer/Glue B. The intention is to create a flexible film that is cured on one side and still only partially cured on the other side. Following that, Porous or Structured Material C (shown in FIG. 4 IV) is deposited in close contact with the partially cured layer of Prepolymer/Glue B (as shown in FIG. 4 V), such that B partially impregnates pores/voids of C. At this stage the Glue B is induced/allowed to fully cure, which produces the laminate of A, B, and C, such that there remains a layer of C that has unfilled voids/pores. The thickness of the unfilled porous material C can be controlled by a variety of methods, but primarily by controlling the amount of Prepolymer/Glue B used. The intention here is to create a flexible laminate with the layer of unmodified (non-infused) C exposed. At this point, the two-dimensional freestanding sheet possesses a pre-SLIPS surface. That is, it is capable of forming a SLIPS surface but in its lubricant-free state does not yet actually have a high slip property.

In order to generate the SLIPS surface, the still unfilled structured/porous network of C is infused with needed amount of an appropriately chosen Lubricant D (as shown in FIG. 4 VI), such that the Lubricant D strongly adheres to and is locked within C, forming an essentially fiat liquid, slippery overlayer. The amount of lubricant needed to fully infuse the unfilled structured/porous network of material C can be adjusted by increasing or decreasing the depth of prepolymer/Glue B into the porous structure. The greater the depth of penetration of glue penetration into the porous layer, the smaller the volume of lubricant needed to infuse the surface. The ability to reduce the amount of lubricant used can be advantageous where the cost of lubricant is high. To ensure the required high affinity and adherence between C and D, the surface of C may be modified/functionalized physically or chemically prior to lubricant infiltration, as necessary, for example, as described in one or more of the following documents, which are incorporated in their entirety by reference: International Patent Application WO 2012/100099 and International Patent Application WO 2012/100100, both filed Jan. 19, 2012, International Patent Application No. PCT/US2013/21056, filed Jan. 10, 2013; and International Patent Application No. PCT/2012/63609, filed Nov. 5, 2012. Additional detail can be found in U.S. Application No. 61/671,442, filed Jul. 13, 2012, entitled SELECTIVE WETTING AND TRANSPORT SURFACES; U.S. Application No. 61/671,645, filed Jul. 13, 2012, entitled HIGH SURFACE AREA METAL OXIDE-BASED COATING FOR SLIPS; and U.S. Application No. 61/673,705, filed Jul. 19, 2012, entitled MULTIFUNCTION REPELLENT MATERIALS, the contents of which are hereby incorporated by reference in their entireties.

If the adhesive layer is desired on the back of the laminate, the appropriate step can be introduced into the process. Alternatively, a backing sheet or tape having preapplied adhesive may be used.

In some embodiments, roll-to-roll manufacture steps are utilized whereby all or a subset of the steps are done in sequence, while rolling the tape from a source roll to a receiver roll.

Material A can be chosen from a variety of commercially available polymers or polymers developed specifically for this purpose (plastics and elastomers, synthetic and natural), metals, metal-polymer laminates, and other flexible composites that can be formed into a film that possesses desired mechanical and surface/adhesion characteristics. In other embodiments, the sheets can be rigid, e.g., tiles, that have a SLIPS surface on one side and a different surface property on the other side.

Prepolymer/Glue B can be chosen from a variety of commercially available, as well as specially formulated prepolymers (and their mixtures with initiators, if necessary), such that it possesses required viscous, viscoelastic, and curing characteristics and properties. The prepolymer/Glue B can be applied to Material A using well known techniques, such as rolling, calendaring, spraying, evaporation, spin coating, slit coating, printing, and painting. In some embodiments, the surface of Material A can be treated, e.g., with an adhesion promoter, to improve adhesion of the prepolymer/glue B to Material A. Exemplary adhesion promoters include plasma etch or chemical etch or treatment.

Structured/porous Material C can be chosen from commercially available polymers, ceramic or metallic foams, as well as fabrics or among those that are designed/synthesized specifically for this purpose. It can be deposited as a whole layer or be grown or coated or sprayed or electrospun or rotary jet-spun on the layer of B. The intention is to create the structured/porous layer of appropriate thickness, mechanical robustness, and chemical/surface/adhesive characteristics. Prepolymer/Glue B and Material C can be applied sequentially or together to the surface of Material A. In certain embodiments, the Material C can be particles, e.g., polymer, glass, metal or ceramic particles. In a particular embodiment, the layer can be ceramic particles, and the sheet is a commercial sand paper having a ceramic/binder composite as the glue and Material C. As mentioned earlier, if necessary, Material C can be further modified/functionalized physically or chemically to ensure its affinity for Lubricant D. Exemplary abrasive materials useful in connection with the present disclosure include, but are not limited to silicon carbide (carborundum), alumina, zirconia, zirconia-alumina, chromium oxide, iron oxide, titanium oxide, glass powder, metal powders or pellets, diamond-like carbon, diamond, fullerite, fumed silica, boron carbide, cubic boron nitride (borazon), garnet, corundum (emery), calcite, novaculite, pumice dust, rouge, sand, and other abrasives that are well-known in the art.

Lubricant D is selected based upon the particular application and materials A, B, and C. Lubricant D may or may not be deposited onto the layer of C as a part of the fabrication method. It can be chosen to be deposited after the structured A-B-C laminate is placed in its target location or immediately prior to the laminate attachment at its target location.

In another embodiment, the freestanding bifunctional sheet or tape is prepared by directly converting one side of a substrate (e.g. aluminum or other metal sheet) to SLIPS from the starting substrate material and the other side of the same substrate material can remain in its original form or be applied with a glue/adhesive layer to form a bifunctional sheet or tape. Many metal oxides, metal oxo-hydroxides, and organic and inorganic metal salts and compounds have natural structured or porous morphology and high roughness factor. The porosity and roughness scale of such metal oxides, metal oxo-hydroxides and salts make them particularly suitable for use as a roughened surface that can be converted into SLIPS surface.

### Roughened Surface

Material C is selected to form a roughened surface on the two-dimensional sheet, either alone or in combination with pre and/or post deposition processing. As used herein, the term “roughened surface” includes both the surface of a three-dimensionally porous material as well as a solid surface having certain topographies, whether they have regular, quasi-regular, or random patterns.

In certain embodiments, the roughened surface may have a roughness factor, R≧1, where the roughness factor is defined as the ratio between the real surface area and the projected surface area. For complete wetting of Liquid B to occur, it is desirable to have the roughness factor of the roughened surface to be greater or equal to that defined by the Wenzel relationship (i.e. R≧1/cos θ, where θ is the contact angle of Liquid B on a flat solid surface). For example, if Liquid B has a contact angle of 50° on a fiat surface of a specific material, it is desirable for the corresponding roughened surface to have a roughness factor greater than ˜1.5.

In certain embodiments, the roughened surface can be manufactured from any suitable materials. For example, the roughened surface can be manufactured from polymers (e.g., epoxy, polycarbonate, polyester, nylon, Teflon, etc.), metals (e.g., tungsten, aluminum, copper, zinc, tin, nickel, bronzes, brasses, steels alloys), sapphire, glass, carbon in different forms (such as diamond, graphite, black carbon, carbon nanotubes, graphene, etc.), ceramics (e.g., alumina, silica, titania, zirconia, hafnia), and the like. For example, fluoropolymers such as polytetrafluoroethylene (PTFE), polyvinylfluoride, polyvinylidene fluoride, fluorinated ethylene propylene, and the like can be utilized. In addition, roughened surface can be made from materials that have functional properties such as conductive/non-conductive, and magnetic/non-magnetic, elastic/non-elastic, light-sensitive/non-light-sensitive materials. A broad range of functional materials can make SLIPS.

In certain embodiments, the roughened surface may be the porous surface layer of a substrate with arbitrary shapes and thickness. The porous surface can be any suitable porous network having a sufficient thickness to stabilize Liquid B, such as a thickness from above 100 nm, or the effective range of intermolecular force felt by the liquid from the solid material. The substrates can be considerably thicker, however, such as metal sheets and pipes. The porous surface can have any suitable pore sizes to stabilize the Liquid B through capillary forces, such as from about 10 nm to about 2 mm. Such a roughened surface can also be generated by creating surface patterns on a solid support of indefinite thickness.

Patterned roughened surfaces can also be obtained in a variety of well-established techniques. In some embodiments, a substrate is patterned with non-uniform chemical functionalization of a structurally uniform substrate.

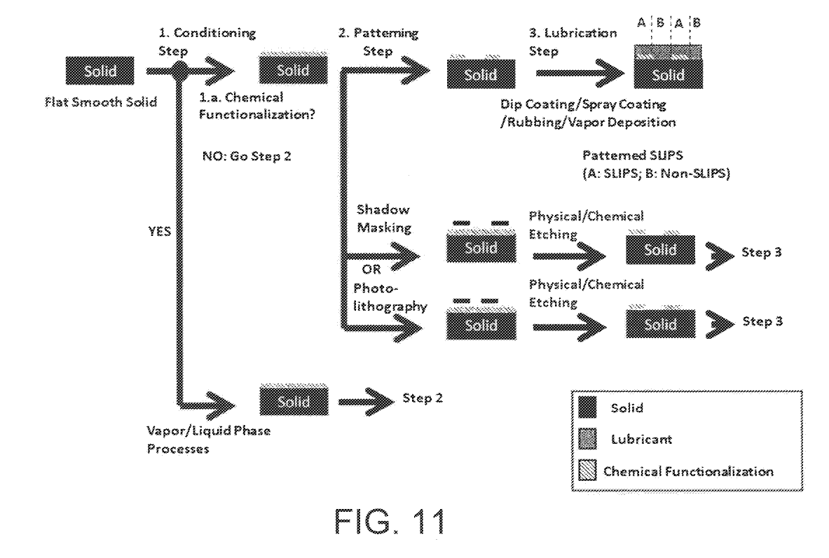

A schematic for a series of processes of making patterned SLIPS on a first side of a fiat smooth sheet is shown in FIG. 11. In some embodiments, a flat smooth sheet is chemically functionalized on a first side by vapor or liquid phase processes, patterned by either shadow masking or photolithography, with the resulting solid being physically or chemically etched. The etched solid is then either dip coated, spray coated, rubbed or subjected to vapor deposition prior to exposure to a lubricating liquid, resulting in patterned SLIPS on the first side. In other embodiments, a flat solid is patterned without chemical functionalization by either shadow masking or photolithography, with the resulting solid being physically or chemically etched on the first side. The etched solid is then either dip coated, spray coated, rubbed or subjected to vapor deposition prior to exposure to a lubricating liquid, resulting in patterned SLIPS on the first side. In some embodiments, the opposing side is further functionalized to provide a dissimilar function from the first side. In further embodiments, the opposing side is unfunctionalized and intrinsically provides a dissimilar function from the first side.

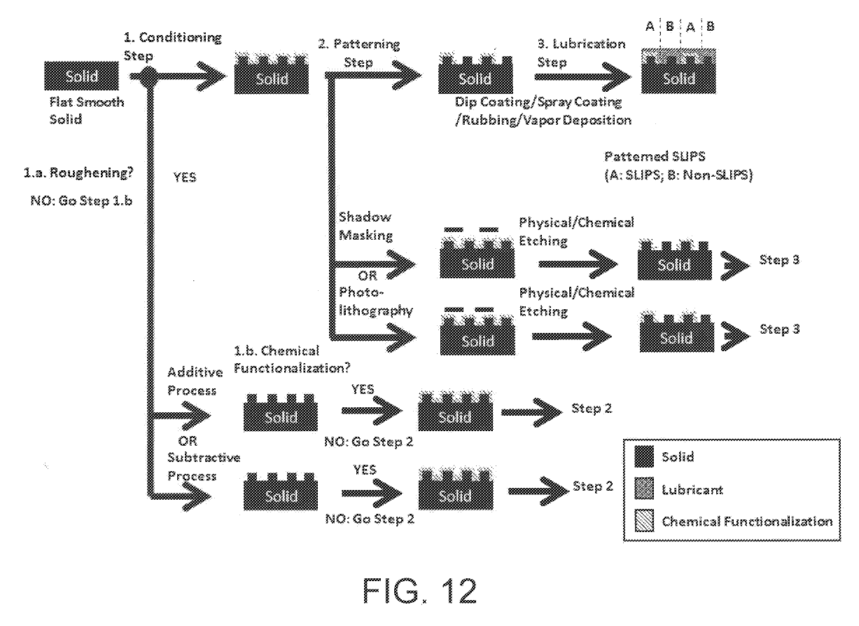

A schematic for a series of processes of making 2.5D patterned, e.g., a surface pattern that is carried out on a first side of a substrate through at least a portion of the thickness of the layer is shown in FIG. 12. In some embodiments, the first side of the solid is roughened either by additive or subtractive processes. The resulting roughened first side of the solid is either chemically functionalized and then patterned, or directly patterned by either shadow masking or photolithography. The first patterned side of the solid is then either physically or chemically etched. The resulting solid can then be dip coated, spray coated, rubbed or undergo vapor deposition. Lastly, a lubricating liquid is added to the first side to form a patterned SLIPS surface. In other embodiments, a solid pre-roughened on a first side is patterned by either shadow masking or photolithography. The first patterned side of the solid is then either physically or chemically etched. The resulting solid can then be dip coated, spray coated, rubbed or undergo vapor deposition. Lastly, a lubricating liquid is added to the first side to form a patterned SLIPS surface. In some embodiments, the opposing side is further functionalized to provide a dissimilar function from the first side. In further embodiments, the opposing side is unfunctionalized and intrinsically provides a dissimilar function from the first side.

Roughening processes known in the art may be used. Exemplary processes for roughening include application of liquid phase material (paint or ink, spray, spin, dip, air brush, screen printing, inkjet printing);
deposition or reaction of gas phase material (CVD, plasma, corona, ALD, PVD),
sputtering or evaporation of metal or metal oxide, composite phase material deposition (particle+binder),
electrodeposition or other solution phase growth of material (conducting polymer, electroplated metal,
electrophoretic deposition of particles, surface-initiated polymerization, mineralization, electroless plating),
gas phase growth of material (nanofibers),
multiple layer deposition (repeated coating, layer-by-layer deposition),
self-assembly of precursor material (minerals, small molecules, biomolecules, polymers, nanoparticles, colloids),
oxidation or other transformation of the substrate material, or
transfer coating and printing (contact printing, pattern transfer).

In some embodiments, the solid used to create SLIPS has chemical affinity for a lubricating liquid. In these embodiments, portions of the solid which are not roughened will also act as SLIPS.

In some embodiments, a substrate is roughened on at least one side using select colloidal deposition. Colloidal deposition can be used to prepare thin films on at least one side of a substrate that gives rise to rough surfaces with effective omniphobic behavior without appreciably of in a detrimental way affecting the optical properties of the substrate. An exemplary colloidal surface coating comprises inverse opal structures, either in form of monolayers (2D) or 3D arrangements of colloids that are backfilled with silica precursor materials. The colloids can be removed to give rise to an inverse porous network of silica. The surface functionalities of the silica can be tuned according to the desired application. Specifically, it can be made hydrophilic, hydrophobic or fluorophilic by silanization reactions utilizing appropriately chosen reactive silanes and/or their mixtures. Other materials can be used for this purpose, including but not limited to titania, zirconia, hafnia and the like. Using fluoro-silanization, a stable SLIPS state is created by addition of fluorinated lubricants. This addition induces omniphobic behavior to the substrate: liquids or dispersions are effectively repelled from the substrate and do not leave traces. Additional details regarding the use of colloidal deposition to prepare roughened surfaces for SLIPS applications is found in co-pending U.S. Provisional application entitled SLIPPERY LIQUID-INFUSED POROUS SURFACES HAVING IMPROVED STABILITY, filed on even date herewith, which is hereby incorporated in its entirety by reference.

Porous materials can be produced through direct modification of an aluminum or other metal sheet or thin film applied to a backing material. The metal component can include Li, Be, B, Na, Mg, Al, Si, K, Ca, Sc, Ti, V, Cr, Mn, Fe, Co, Ni, Cu, Zn, Ga, Ge, Rb, Sr, Y, Zr, Nb, Mo, Ru, Rh, Pd, Ag, Cd, In, Sn, Sb, Cs, Ba, Hf, Ta, W, Re, Os, Ir, Pt, Au, Tl, Pb, Bi, La, Ce, Pr, Nd, Sm, Eu, Gd, Tb, Dy, Ho, Er, Tm, Yb, Lu, or a combination thereof. The article can be flexible and modified on the back side with an adhesive or other functional property to provide a bifunctional article. In some embodiments, a roughened surface based on a metal-containing compound can be fabricated on a thin metal film created on a metal or nonmetal substrate. The thin metal film can be deposited on the substrate using conventional methods such as vapor deposition (chemical vapor deposition (CVD), atomic layer deposition (ALD), physical vapor deposition (PVD), etc.), sputter deposition, electron beam evaporation, electro- or electroless plating, and the like. In some embodiments, a roughened surface based on a metal-containing compound can be fabricated on a metal-containing solution-based mixture (e.g., sol-gel coating) deposited on a metal or nonmetal substrate. The solution-based mixture can be applied by various application methods including spraying, dip coating, painting, spin coating, flow coating, printing, drop casting, etc. to provide a thin film on a sheet, ribbon or tape. Such mixtures can include sol-gel precursors to metal oxides, metal hydroxides, metal oxy hydroxides, or dispersions containing metal oxides, metal hydroxides, or metal oxy hydroxides. The solution-based mixture can also have porogen to enhance the porous structure. All the methods mentioned above can provide a metal-containing surface on a substrate. As discussed above, the metal-containing surface can be an integral part of the substrate or a distinct component formed or deposited on the substrate. Various other implementations are possible.

Once a metal-containing surface is formed, the metal-containing surface can be chemically modified to form a surface structure with proper feature sizes, volume, density, and morphology, suitable as a porous surface for SLIPS. Chemical modification of metal-containing surface can include reacting the surface with the environment, such as the air, water, alcohol, or acid, to form a metal-containing compound with desired micro- or nano-structure, such as oxide, hydroxide, oxi-hydroxide, or salt. One exemplary process is hydrolysis, where the metal-containing surface is reacted with water in a certain temperature range to form nanostructured oxide or oxo hydroxide. Another exemplary process is oxidation with organic acid to form structured metal salt. Another exemplary process is growth of metal oxide nanorods on metallic supports. Yet another exemplary process is formation of nanoporous coatings using sol-gel deposition of metal oxides mixed with sacrificial porogen.

Once the desired surface micro- or nano-structure is formed, it can be further chemically functionalized to provide the desired chemical affinity for the lubricating liquid (Liquid B).

In one or more embodiments, a boehmite (e.g., aluminum oxide hydroxide or AlO(OH)) coating can be formed on a wide range of substrates to prepare the roughened substrate surface for SLIPS forming. Boehmite coating can be prepared through various processes. The boehmite coating provides a uniform nanostructure for use as the roughened substrate. One exemplary process of creating boehmite on aluminum includes reaction of aluminum with water to form aluminum hydroxide, followed by heat treatment to convert the aluminum hydroxide layer into boehmite (a.k.a. boehmitization). The reaction with water can be conducted in a variety of ways, including heating or boiling in water, e.g., at a temperature of 40-100° C. and steam exposure, e.g., at temperatures of 100-250° C. Exposure times can vary from a few minutes to a few hours, e.g., from 1 minute to 24 hours, 1-60 minutes, or 1-5 minutes of 5-30 minutes or 5-15 minutes. The aluminum substrate can be smooth and unstructured, the boehmitization process providing the desired texture. In other embodiments, the aluminum substrate can have an initial roughened surface, in which case the boehmite process provides an additional hierarchy of surface features. In another exemplary example, aluminum can be sandblasted to create hierarchical roughness, followed by ultrasonic cleaning in acetone and finally boiling in distilled water. The resulting boehmite surface can then be chemically modified by a number of methods known in the art. In some embodiments, the substrate can be partially or selectively functionalized in this manner, resulting in a substrate with both roughened and non-roughened regions.

A solution-based mixture can be used to fabricate SLIPS on arbitrary metal or non-metal substrates. The mixture can be applied by various application methods including spraying, dip coating, painting, spin coating, printing, drop casting, etc. Such mixtures can include sol-gel precursors to metal oxides, metal hydroxides, metal oxy hydroxides, or dispersions containing metal oxides, metal hydroxides, metal oxy hydroxides, where the metal component can include Li, Be, B, Na, Mg, Al, Si, K, Ca, Sc, Ti, V, Cr, Mn, Fe, Co, Ni, Cu, Zn, Ga, Ge, Rb, Sr, Y, Zr, Nb, Mo, Ru, Rh, Pd, Ag, Cd, In, Sn, Sb, Cs, Ba, Hf, Ta, W, Re, Os, Ir, Pt, Au, Tl, Pb, Bi, La, Ce, Pr, Nd, Sm, Eu, Gd, Tb, Dy, Ho, Er, Tm, Yb, Lu, or a combination thereof. The sol-gel precursor can be deposited on arbitrary shapes, and then converted into a corresponding metal oxide, metal hydroxide, or metal oxy hydroxide, or salts. In some embodiments, a solution-processed thin coating material can be further reacted to induce nanostructures. In some embodiments, the entire coating layer is chemically modified to contain nanostructures. In some embodiments, only an upper portion of the coating layer is chemically modified to contain nanostructure. In some embodiments, the solution-based mixtures can include porogens to introduce or enhance porosity.

In some embodiments, an adhesion promoter can be used to enhance the adhesion between the metal-containing layer and the underlying substrate. For example, dopamine or polydopamine can be used as an adhesion promoter and applied onto a substrate before or when a sol-gel precursor is applied.

In some embodiments, the underlying substrate is chemically or plasma-activated (or preconditioned) to enhance the adhesion between the metal-containing layer and the underlying substrate.

In some embodiments, SLIPS can be formed on boehmite surface based on alumina sol-gel. For example, alumina sol-gel film can be further treated with hot water or steam to create aluminum oxy hydroxide (boehmite) nanostructure. These procedures can help create nanoporous structures. All of these nanostructured or nanoporous materials can be subsequently functionalized (e.g. fluorination, alkylation) and lubricated to fabricate SLIPS on arbitrary materials.

SLIPS surfaces can also be made from transparent sol-gel alumina-based boehmite coatings. For example, an alumina sol-gel precursor can be prepared from aluminum tri-tert-butoxide, ethylacetoacetate, 2-propanol and water and then spin or spray coated on a substrate, dried and treated with water to provide a thin boehmite coating which can be subsequently used to form a SLIPS surface. Sol-gel coatings can be applied to a variety of substrates, such as polysulfone, poly(methyl methacrylate) (PMMA), polycarbonate, polystyrene, polyurethane, epoxy, polyolefins, polyvinylchloride (PVC), polyethylene terephthalate (PET), glass and stainless steel. Sol-gel coatings can be applied in a variety of thicknesses, for example, 100 nm, 110 nm,150 nm, 200 nm, 250 nm, 300 nm, 400 nm, 500 nm, 1 μm, 2 μm, 5 μm, and 10 μm. In some embodiments, sol-gel derived boehmite coatings are transparent and/or anti-reflective.

In one embodiment, a sol-gel alumina-based boehmite coating is prepared. An alumina sol-gel precursor is produced by mixing aluminum tri-tert-butoxide, ethylacetoacetate, 2-propanol and water. The concentration of alumina precursor in 2-propanol can be adjusted to control the viscosity of the sol-gel precursor solution. The concentration of the stabilizer, ethylacetoacetate, should be increased proportionally with increasing the alumina precursor content. The amount of water added controls the rate of hydrolysis and the pot life of the sol-gel mixture. An exemplary mixture is prepared by dissolving 3 g of aluminum tri-tert-butoxide in 30 mL of 2-propanol, then dissolving 2 mL of ethylacetoacetate and stirring for at least 1 h, followed by slow addition of 6 mL of 5:1 (v/v) 2-propanol:water mixture. The resulting composition can be further diluted with 2-propanol and is spray- or spin-coated on a substrate at 100 to 12,000 rpm, and the substrate is dried at 60° C. to 400° C. for 1 hour to 3 days. The substrate is then treated with water at 40° C. to 100° C. for 10 minutes to 2 days to form a boehmite-coated substrate.

In another embodiment, a boehmite surface is prepared on an aluminum sheet. Aluminum metal is sandblasted at 30 psi using 120 grit sand. The resulting sandblasted metal is ultra sonicated in acetone for 15 minutes, dried, and boiled in water for 10 minutes to produce a boehmite surface.

Once the boehmite roughened surface is formed, it can be further chemically functionalized to provide the desired chemical affinity for the lubricating liquid. Functionalized silanes, carboxylates, phosphonates, and phosphates are common reactants with which to modify the chemical nature of the boehmite surface.

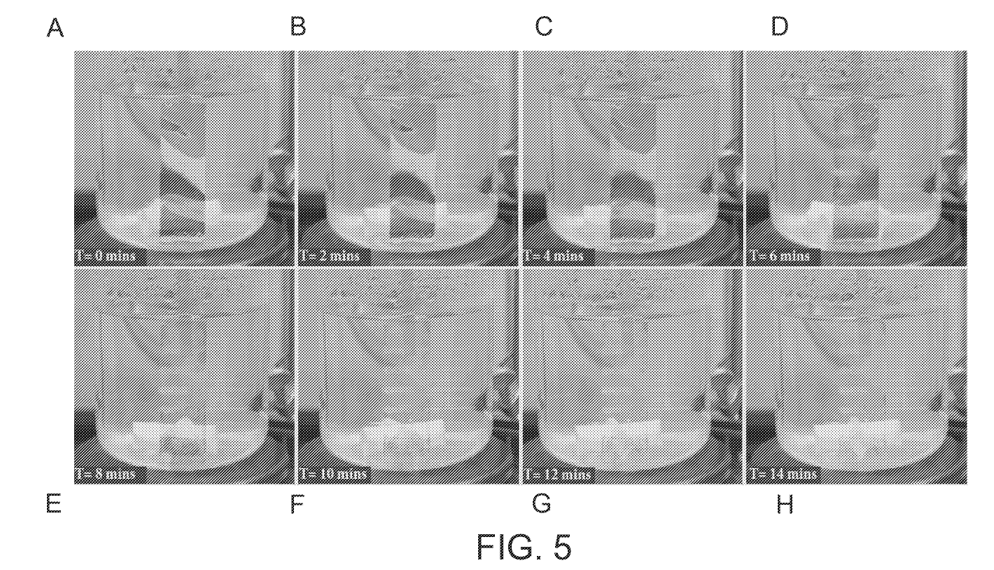

In another example, one side of the substrate (e.g., PET sheet) can be aluminized both by sol gel or ALD/CVD processes and can be boehmitized and functionalized, then lubricated to form SLIPS on the aluminized surface. The backside of the same substrate can have optional adhesive layer. If the thickness of the aluminum is sufficiently thin, the entire film can be made optically transparent. This process is illustrated in FIG. 5. FIG. 5 is a series of time lapse images of aluminized PET sheet (˜100 nm thick aluminum; available from Flexcon) undergoing boehmitization in a 70° C. water bath. This procedure turns a mirror-like film shown in FIG. 5A into an optically transparent film shown in FIG. 5H as the aluminum metal is transformed into a transparent material, boehmite, by the reaction between water and aluminum. The boehmitized side is then chemically functionalized by dipping in an ethanol bath containing 1 wt. % of fluoroalkylphosphonate surfactant (FS100, Mason Chemicals Co.) at 70° C. for 3 min-1 hr (or at room temperature for >4 hr) and lubricated with DuPont PFPE Krytox lubricant GPL 100 to form SLIPS, while an adhesive layer is applied to the opposite side. This procedure produces art attachable bifunctional tape form of SLIPS. Further detail on the use of meta-containing structures for SLIPS applications can be found in U.S. Provisional Patent Application No. 61/671,645, filed on Jul. 13, 2012, and in co-pending International patent application entitled “SLIPS SURFACE BASED ON METAL-CONTAINING COMPOUND,” which is incorporated in its entirety by reference.

In some embodiments, manufacture is carried out in a roll-to-roll-process. In some embodiments, a backing material containing an aluminized surface is fed off of one roll, exposed to steam on the aluminized surface to convert the aluminum to boehmite, and then taken up on a second roil. In some embodiments, the backing further comprises an adhesive applied to the opposing side. In some embodiments, the processes take place sequentially or simultaneously.

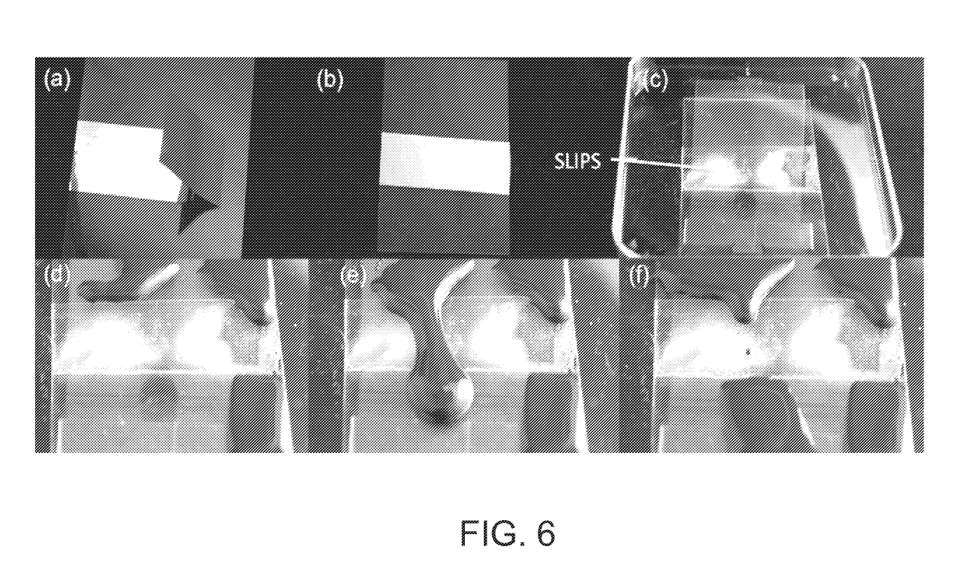

In some embodiments, the final steps of SLIPS formation are performed by the end user, optionally after the bifunctional sheet has been attached to a body. FIG. 6 is an illustration of this practice. FIGS. 6A and 6B are photographs showing an aluminized film tape (available from FLEXcon) being attached in the center of a glass slide. This is similar to an end user applying the pre-SLIPS bifunctional tape to a body targeted for SLIPS application. The adhered tape is then submersed into a 70° C. water bath. This procedure turns a mirror-like film into an optically transparent film as the aluminum metal is transformed into a transparent material, boehmite, by the reaction between water and aluminum, as shown above and in FIG. 6C. The treated surface is then transformed into a SLIPS surface by chemical functionalization by dipping in an ethanol bath containing 1 wt. % of fluoroalkylphosphonate surfactant (FS100, Mason Chemicals Co.) at 70° C. for 1 hr and lubrication with DuPont PFPE Krytox lubricant GPL 100 to form SLIPS. The slippery property of the tape is demonstrated in FIGS. 6D-6F. An extremely sticky complex liquid—liquid asphalt—is applied to the top bare glass surface drop by drop to demonstrate the non-wetting property of the SLIPS taped area and highly contaminated regular surface bearing no SLIPS tape.

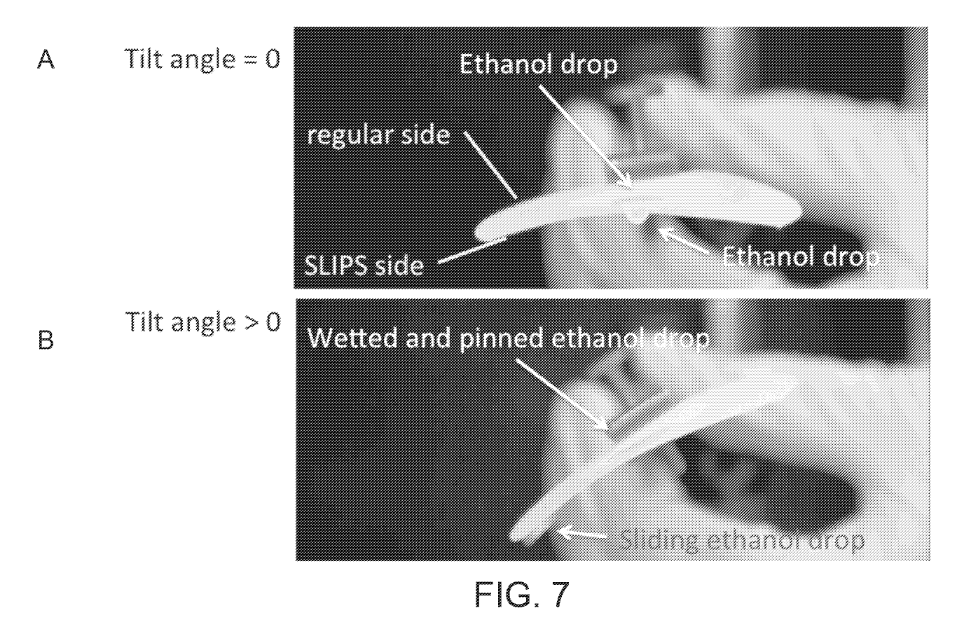

In another example, one side of a porous substrate (e.g., a filter paper or porous membranes such as polyester mesh, steel mesh) can be coated with SLIPS while the other side can remain untreated and thereby exhibit regular wetting properties. FIGS. 7A and 7B are photographs of a bifunctional sheet having a side demonstrating SLIPS made on a filter paper. The porous membrane was placed in an inductively coupled plasma reactive ion etching (TCP RIE) plasma etcher (Surface Technology Systems MPX/LPX) with one side (denoted “regular side” in FIG. 7A) attached onto the stage substrate and the other side (denoted “SLIPS side” in FIG. 7A) up and exposed to the plasma etching. The exposed side of the membrane was first cleaned with oxygen plasma for 2-10 mm and on it was deposited a thin layer of a fluorocarbon coating (C₄F₈ plasma for 10-120 s), depending on the porosity/wettability of the membrane. After this treatment, the treated side becomes superhydrophobic, while the protected side becomes moderately hydrophobic. After infusing with fluorinated lubricant (DuPont Krytox GPL 100), a stable slippery surface is made on the SLIPS side, while a non-stable slippery surface is made on the regular side. Low surface tension liquid droplet (e.g. ethanol) can slide on the SLIPS-treated side (bottom) with little tilting while the droplet wets on the untreated side (top).

Other conventional means to treat the porous substrate may be used to render one side of the sheet with a high slip surface. For example, one side of the paper can be treated using a hydrophobic material, such as hydrocarbon or silicon waxes. The wax can be applied to one side of the paper using conventional printing and heating methods. See, for example, “Understanding Wax Printing: A Simple Micropatterning Process for Paper-Based Microfluidics”, Carrilho et al., Anal. Chem. 2009, 81, &09107095 (2009), which is incorporated in its entirety by reference.

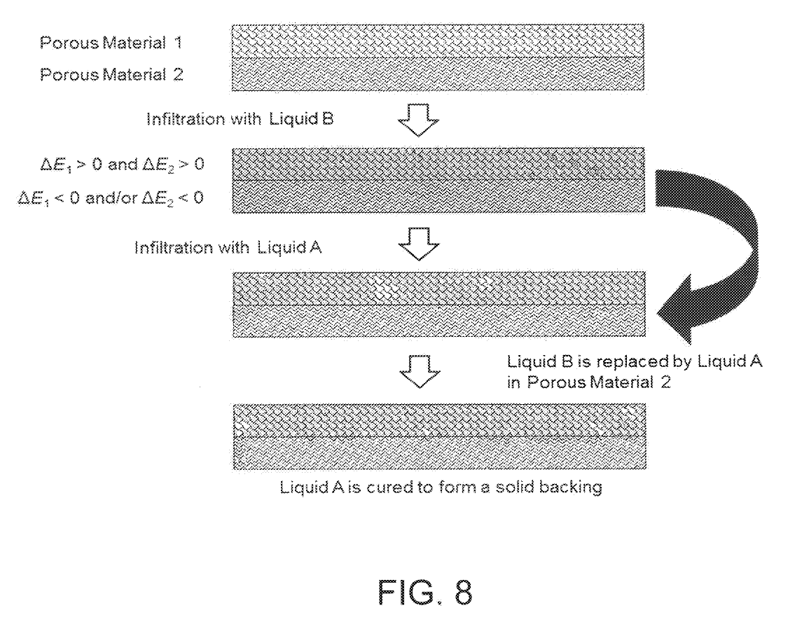

FIG. 8 shows an exemplary embodiment of the present disclosure in which a two dimensional article having different functional surfaces is prepared from a single substrate having different surface properties or by using a bilayer substrate having different surface properties. In the embodiment shown in FIG. 8, the substrate is made up of two different porous materials, Porous Material 1 and Porous Material 2. The surface properties may differ, for example, by providing different surface modification to either side of the substrate or by adhering two layers of different properties in facing relationship. The substrate is then infiltrated with Liquid B. Liquid B and Porous Material 1 have matching surface energy such that the liquid will be stably attached within the porous material, while Liquid B and Porous Material 2. do not have matching surface energy. By way of example, the substrate is a porous sheet that is treated to have a surface energy affinity to a lubricating liquid used to form the SLIPS surface. The article is then exposed to Liquid A that has a greater affinity for Porous Material 2. Liquid B that is trapped, but not stably attached, within the Porous Material 2 will be displaced. In certain embodiments, Liquid A can be a liquid epoxy precursor. Liquid A is then cured to form a solid backing. In some embodiments, Liquid B forms a meta-stable attachment to Porous Material 2. A meta-stable state is created when the lubricant's low surface tension wets the surface but a “lock in”, that is, the energetic minimum situation is not supported by the surface chemistry. As a result, the SLIPS state will eventually break down, upon addition of a second liquid. However, this may take time, and the surface is in a SLIPS state until the stable surface liquid is disrupted. Thus, a meta-stable slips surface can be created even though the conditions for thermodynamic stability are not satisfied. A meta-stable state could also be created on a surface on which the supporting roughness is not high enough to allow a stabilized liquid layer (SLIPS) to form.

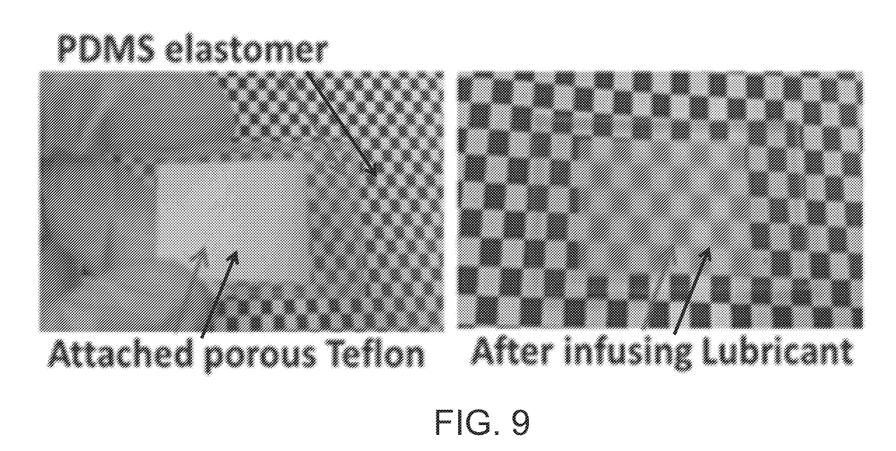

In another example, the procedure for making a bifunctional sheet having a lubricant-infused Teflon layer (acting as SLIPS surface) attached to a flexible PDMS backing (acting as an conformal adhesive is described. A Teflon porous membrane with average pore size of ˜200 nm and thickness of ˜45 μm (purchased from Sterlitech Corporation, Wash., USA) was integrated with an elastic PDMS film (0.5˜1.5 μm thick), by using a thin layer of PDMS oligomer as adhesive. The PDMS film was first activated by O₂ plasma treatment for 10 s. A thin layer of PDMS curing precursor (Dow Corning Sylgard 184, 1:10) was then coated on the substrate, and placed in a 70° C. oven for 15-20 min to obtain partially polymerized, sticky oligomer. The porous Teflon membrane was attached on the sticky layer under the pressure of ˜1000 Pa. The additional pressure/load is applied on the membrane to ensure the attachment of the membrane in ambient condition. The sticky PDMS oligomer slightly penetrates into the porous Teflon membrane and thus thinly attaches the nanofiber networks to the elastic substrate. Then the integrated multilayer was placed in the 70° C. oven for 2 h to ensure the full curing. Lubricating fluid was added onto the surfaces by pipette to form an overcoated layer. With matching surface chemistry and roughness, the fluid will spread onto the whole substrate through capillary wicking. The thickness of the overcoated layer can be controlled by the fluid volume given a known surface area of the sample. The lubricating fluid used for the experiment was perfluorinated fluid, DuPont™ Krytox® 103 perfluoropolyether. FIG. 9 shows photographs of thus prepared bifunctional films. This bifunctional sheet can be attached to a checkerboard, while the pure/or single-functional SLIPS cannot do this because of the non-sticky property.

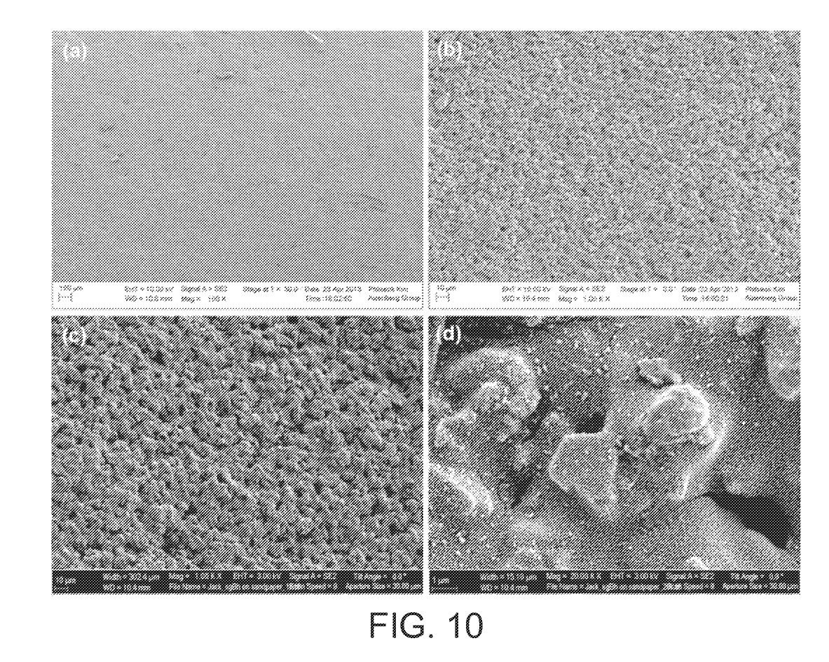

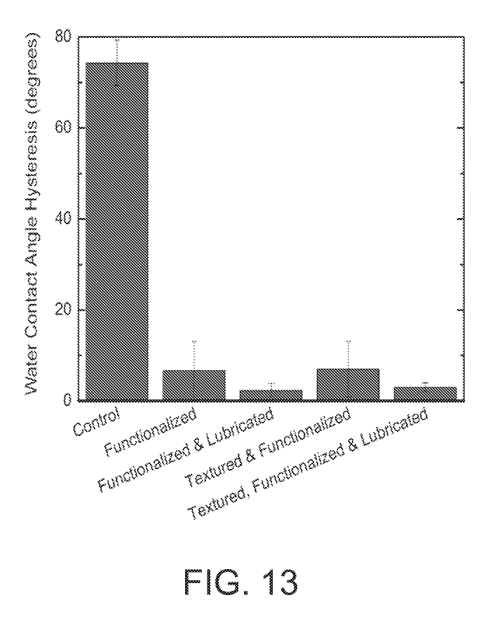

In another example, mechanically robust SLIPS is prepared using conventional sandpaper materials with optional adhesives attached to the backside of the sandpaper. Fine grit (#2500) alumina sandpaper has inherent microscale porosity. As shown in FIGS. 10A-B, the ‘as received’ fine grit sandpaper is inherently rough. FIGS. 10C-D show the same sandpaper after addition of nanotexture (boehmite formation from the alumina oxide particles) and fluorination. An additional nanostructure, for example sol-gel alumina-derived boehmite, may be added on top of inherent microscale porosity. The surface fluorination was performed using C₄F₈ plasma for both as received and nanotexture-added sandpaper samples. After fluorination, both samples were infused with a lubricant that was suitable for the fabrication of SLIPS. These surfaces provided a mechanically robust SLIPS substrate. FIG. 13 shows significant reduction in water contact angle hysteresis for combinations of functionalized, lubricated and textured sandpaper as compared to unmodified sandpaper. In FIG. 13, “Control” refers to unmodified 2500 grit alumina sandpaper, “Functionalized” refers to 2500 grit alumina sandpaper fluorinated with C₄F₈ plasma, “Textured” refers to refers to 2500 grit alumina sandpaper with boehmite overcoating applied using sol-gel alumina, and “Lubricated” refers to 2500 grit alumina sandpaper lubricated with Krytox 100.

Mechanically robust sandpaper SLIPS can be produced as consumer products (laminates, sheets, films). The adhesive, abrasive, and lubricant can be provided as separate cans that can be applied by the consumers. Potential applications include rooftops for anti-ice applications, leading edges of aircraft, wind turbine, marine vessels, recreation gear, and wherever a mechanically robust SLIPS is desirable.

The advantages of the reported fabrication methods are as follows:
1. It significantly adds to modularity of the platform SLIPS technology, by providing an easy access to flexible thin, structured, lubricant-deposition-ready films and sheets that can be used to wrap around or glued onto the surfaces, for which SLIPS-type repellant behavior is desired. All current approaches are based on modification of existing surfaces, rather than on applying a ready-to-use film or cover
2. It is compatible with a variety of materials for i) support (Material A) ii) glue (Material B), and iii) functional structured/porous layer (Material C)
3. It is compatible with applying adhesive layer (with or possibly even without additional protective sacrificial layer) on the backside of the laminate, thus allowing it to be incorporated into an adhesive film-type product that can be cut in pieces of desired sizes and applied where and when needed
4. It is compatible with various geometric shapes, including pipes/tubing, when a porous tubing alone is insufficiently mechanically robust and is prone to losing the lubricant through the leakage or other losses through its outer surface
5. It allows to carefully calibrate and adjust the available free volume of the structured/porous network of Material C, thus facilitating minimization of the use of lubricants—an important cost consideration for relatively expensive types of lubricants
6. It is expected to be easily scalable—in the manufacture of sheets and especially, of continuous films, due to the possibility to integrate it into press- and roll-to-roll type processes
7. It can be used together or in combination with other double-sided adhesive tapes designed to attach to a desired surface and to the non-SLIP side of the bifunctional film and acting as an adhesive film
8. SLIPS coating can be directly formed on the existing tapes, papers and films
9. It allows for mechanically robust SLIPS where appropriate as well as easy replacement and/or repair of damaged SLIPS thus allowing for the applicability of SLIPS to various applications where mechanical durability of SLIPS can be a potential issue.

The bifunctional sheet can be used to apply a SLIPS surface on site and can be used on surfaces that cannot be readily transformed into a SLIPS surface. Exemplary applications include as anti-ice sheets, anti-graffiti films, anti-insect barriers/wraps, anti-(bio)fouling tubing and catheters, anti-dirt road-signs, anti-fouling vessel liners (reactors, biomass growing trays, etc.), transparent anti-fouling and self-cleaning laminate sheets for solar panels, windows, lenses, shingles, tiles, patch sheets/stickers/tapes to repair a portion of existing SLIPS surfaces, etc.

Those skilled in the art would readily appreciate that all parameters and configurations described herein are meant to be exemplary and that actual parameters and configurations will depend upon the specific application for which the systems and methods of the present invention are used. Those skilled in the art will recognize, or be able to ascertain using no more than routine experimentation, many equivalents to the specific embodiments of the invention described herein. It is, therefore, to be understood that the foregoing embodiments are presented by way of example only and that the invention may be practiced otherwise than as specifically described. The present invention is directed to each individual feature, system, or method described herein. In addition, any combination of two or more such features, systems or methods, if such features, systems or methods are not mutually inconsistent, is included within the scope of the present invention.

What is claimed is:

1. A bifunctional article having different surface properties on opposing sides, comprising:
a sheet having a first side and a second side,
wherein the first side displays low adhesion properties, said first side comprising a roughened, porous or structured surface and a wetting liquid disposed upon the surface to form a stable liquid film; and
wherein the second side displays a second property dissimilar from that of the first side.

2. The bifunctional article of claim 1, wherein the sheet is free standing.

3. The bifunctional article of claim 1, wherein the sheet is shaped to conform to a surface having a predetermined shape.

4. The bifunctional article of claim 1, wherein the sheet is rigid.

5. The bifunctional article of claim 1, wherein the sheet is flexible.

6. The bifunctional article of claim 1, wherein the second property is selected from the group consisting of wettability by a selected liquid other than the wetting liquid, stickiness and adhesiveness.

7. The bifunctional article of claim 6, wherein the second property is adhesiveness,

8. The bifunctional article of any one of claims 1-7, wherein the second side comprises an adhesive layer.

9. The bifunctional article of claim 8, wherein the adhesive layer is suitable for permanent adhesion so the surface of an object.

10. The bifunctional article of claim 8, wherein the adhesive layer is suitable for reversible adhesion to the surface of an object.

11. The bifunctional article of claim 8, wherein the adhesive layer is pressure sensitive.

12. The bifunctional article any one of claims 1-11, wherein the first side comprises a SLIPS disposed on the first side of the sheet.

13. The bifunctional article of claim 12, wherein the SLIPS layer comprises a porous or structured micro/nanomaterial secured to the substrate using an adhesive.

14. The bifunctional article of claim 13, wherein the SLIPS layer comprises a porous material and the adhesive penetrates into a lower portion of the porous material.

15. The bifunctional article any one of claims 1-11, wherein the first side comprises a SLIPS layer integral with the sheet.

16. The bifunctional article of any one of claims 1-15, further comprising a protective layer disposed over one or both of the first and second sides of the sheet.

17. The bifunctional article of claim 16, wherein the protective layer is a sacrificial layer.

18. The bifunctional article of any preceding claim, wherein the article is wound article, optionally including a supporting mandrel.

19. The bifunctional article of any preceding claim, wherein the article is a film, tape, tile, fabric, paper, sleeve, or thin coating.

20. The bifunctional article of any preceding claim, wherein the article is housed in a protective housing to reduce loss of wetting liquid during storage.

21. The bifunctional article of any preceding claim, wherein the article has a thickness in the range of about 1 μm to about 1 cm.

22. The bifunctional article of any preceding claim, wherein the article has a thickness in the range of about 1 cm to about 10 cm.

23. The bifunctional article of claim 1, wherein the sheet comprises polydimethylsiloxane and the roughened, porous or structured surface comprises a polytetrafluoroethylene sheet, said polytetrafluoroethylene sheet secured to the polydimethylsiloxane sheet by cured polydimethylsiloxane precursor.

24. The bifunctional article of claim 1, wherein the sheet is a bilayer and the first layer of the bilayer has a surface displaying the low adhesion properties and the second layer of the bilayer has a surface displaying the second dissimilar property.

25. The bifunctional article of claim 1, wherein the sheet comprises a single porous sheet having different surface chemistry on the first and second sides of the substrate, the first surface chemistry displaying the low adhesion properties and the second surface chemistry displaying the second dissimilar property.

26. The bifunctional article of claim 1, wherein the first roughened, porous or structured surface comprises an aluminum oxide composite layer comprising particles of aluminum oxide and a binder.

27. The bifunctional article of claim 26, wherein a portion of the aluminum oxide particles comprise boehmite.

28. A method of making an article having different surface properties on opposing sides, comprising:
providing a substrate having a first side and a second side, the second side optionally containing an adhesive backing,
applying a glue layer, said layer having a thickness, on the first side of the substrate; and
locating a porous or structured layer in the glue layer, the porous or structured comprising at least one of pores and voids;
wherein the glue partially infuses through at least a portion of the thickness of the porous or structured layer into at least one of the pores and voids of the porous or structured layer, and
wherein there remains a portion of the thickness of the porous or structured layer that has at least one of unfilled voids and unfilled pores.

29. The method of claim 28, wherein the thickness of the glue layer is selected to infuse the glue through a predetermined portion of the thickness of the porous or structured layer which is less than the total thickness of the porous or structured layer.

30. The method of any one of claims 28 or 29, wherein the method is conducted in a roll-to-roll continuous process.

31. The method of any one of claims 28-30, wherein the substrate comprises polydimethylsiloxane sheet, the glue comprises a curable polydimethylsiloxane precursor, and the porous or structured layer comprises a porous polytetrafluoroethylene sheet; and
wherein the curable polydimethylsiloxane precursor is cured after infusing the polytetrafluoroethylene sheet with the curable polydimethylsiloxane precursor.

32. A method of making an article with different surface properties on opposing sides, comprising;
continuously feeding out a substrate from a roil into coating zone, said substrate comprising a reactive layer on a first side of the substrate and optionally containing an adhesive backing on the second side of the substrate;
converting the reactive layer into a porous or structured layer in the reaction zone; and
taking up the substrate comprising a porous or structured layer on a receiving roll at a location outside of the reaction zone.

33. The method of claim 32, wherein the reactive layer comprises an aluminum layer and the reactive zone comprises a heated zone with high moisture content.

34. The method of claim 32, wherein the reactive zone comprises at least one of particle spraying, sandblasting, embossing, imprinting, electrodeposition and surface etching.

35. The method of any one of claims 28 or 32, further comprising:
applying a wetting liquid to the porous or structured layer, wherein the wetting liquid fills at least one of the unfilled voids and unfilled pores of the porous or structured layer and forms a stable liquid film over the porous or structured layer.

36. The method of claim 35, further comprising:
applying a protective layer over one or both of the porous or structured layer and second side optionally containing an adhesive backing.

37. A method of applying a SLIPS surface to an object, comprising:
providing an article according to any of claims 1-27; and
contacting the second side of the article to an exposed surface of the object, said contacting causing an adhesive layer to adhere the second side of the article to the exposed surface of the object.

38. The method of claim 37, wherein the second side comprises an adhesive layer.

39. The method of claim 38, wherein the adhesive layer comprises a double-stick sheet having an adhesive layer on both sides, such that one side of the double-stick sheet adheres to the exposed surface of the object and the other of the double-stick sheet adheres to the second side of the article.

40. The method of any one of claims 37-39, wherein the first side of the article is selected for protection of the object against one or more of contamination by liquids, complex fluids, solid, insects and microorganisms.

41. The method of any one of claims 37-39, wherein the first side of the article is selected for imparting one or more of anti-icing, anti-graffiti, anti-dirt, antifouling or anti-biofouling properties to the object.

42. A method of making an article with different surface properties on opposing sides, comprising;
providing a sheet comprising a composite of aluminum oxide particles and binder on a first side:
subjecting at least the first side to an elevated temperature in the presence of water to convert at least a portion of the aluminum oxide to boehmite; and
applying a wetting liquid to the boehmitized surface, the wetting liquid selected to form a stable film on the boehmitized surface.

43. The method of claim 42, wherein the boehmitizied surface is chemically modified to improve the stability of the wetting liquid on the boehmitized surface.
